(19) United States
(12) Patent Application Publication
(10) Pub. No.: US 2016/0373661 A1
(43) Pub. Date: Dec. 22, 2016

(54) CAMERA SYSTEM FOR GENERATING IMAGES WITH MOVEMENT TRAJECTORIES

(71) Applicant: Chengdu CK Technology CO., LTD., Chengdu (CN)

(72) Inventor: Shou-chuang Zhang, Chengdu (CN)

(21) Appl. No.: 15/169,384

(22) Filed: May 31, 2016

(30) Foreign Application Priority Data
Jun. 16, 2015 (CN) 2015103320203

(51) Int. Cl. H04N 5/272; G06T 7/20; H04N 5/232

(52) U.S. Cl. CPC H04N 5/272; H04N 5/23216; H04N 5/23293; G06T 7/20; G06T 2207/30221; G06T 2207/30241

(57) ABSTRACT

The present disclosure relates to a sports camera system that can generate an incorporated image with a movement trajectory of an object-of-interest. The system includes a data collection component, an image component, an analysis component, a trajectory-generation component, an image-incorporation component and a display. The data collection component collects multiple sets of three-dimensional (3D) location information of the object-of-interest at different time points. The image component collects an image (e.g., a picture or video) of the object-of-interest. The analysis component identifies a reference object (e.g., a mountain in the background of the collected image) in the collected image. The system then accordingly retrieves 3D location information of the reference object. Based on the collected and retrieved 3D information, the trajectory-generation component then generates a trajectory image. The image-incorporation component forms an incorporated image by incorporating the trajectory image into the image associated with the object-of-interest. The incorporated image is then visually presented to a user.

### CROSS-REFERENCE TO RELATED APPLICATIONS

This application claims the benefit of Chinese Patent Application No. 2015103320203, filed Jun. 16, 2015 and entitled “A MOTION CAMERA SUPPORTING REAL-TIME VIDEO BROADCAST,” the contents of which are hereby incorporated by reference in its entirety.

### BACKGROUND

Sports cameras are widely used to collect images of a sports event or an outdoor activity. For example, a skier can use a sports camera to film images of his trip sliding down from a mountain top to the ground. Traditionally, if the user wants to know what the trajectory of his trip was, he needed to bring additional location-sensor device (e.g., a GPS device) so as to track his movement. It is inconvenient for the user to bring extra devices. Also, when the user reviews the collected images later, it is sometimes difficult to precisely identify the locations where the images were taken. Therefore, it is advantageous to have an improved system and method that can address this problem.

### BRIEF DESCRIPTION OF THE DRAWINGS

Embodiments of the disclosed technology will be described and explained through the use of the accompanying drawings.

FIG. 1 is a schematic diagram illustrating a system in accordance with embodiments of the disclosed technology.

FIG. 2A is a schematic diagram illustrating an object-of-interest and a reference object in accordance with embodiments of the disclosed technology.

FIG. 2B is a schematic diagram illustrating a trajectory of an object-of-interest in accordance with embodiments of the disclosed technology.

FIGS. 2C-2E are schematic diagrams illustrating trajectory images of an object-of-interest in accordance with embodiments of the disclosed technology.

FIG. 3A-3C are schematic diagrams illustrating user interfaces in accordance with embodiments of the disclosed technology.

FIG. 4 is a flow chart illustrating operations of a method in accordance with embodiments of the disclosed technology.

The drawings are not necessarily drawn to scale. For example, the dimensions of some of the elements in the figures may be expanded or reduced to help improve the understanding of various embodiments. Similarly, some components and/or operations may be separated into different blocks or combined into a single block for the purposes of discussion of some of the embodiments. Moreover, although specific embodiments have been shown by way of example in the drawings and described in detail below, one skilled in the art will recognize that modifications, equivalents, and alternatives will fall within the scope of the appended claims.

### DETAILED DESCRIPTION

In this description, references to “some embodiment”, “one embodiment,” or the like, mean that the particular feature, function, structure or characteristic being described is included in at least one embodiment of the disclosed technology. Occurrences of such phrases in this specification do not necessarily all refer to the same embodiment. On the other hand, the embodiments referred to are not necessarily mutually exclusive.

The present disclosure relates to a camera system that can generate an incorporated image with a three-dimensional (3D) trajectory of an object-of-interest in a real-time fashion. Examples of the object-of-interest include moving creatures or moving items such as a person, a wild animal, a vehicle, a vessel, an aircraft, a sports item (e.g., a golf ball), etc. The incorporated image can be created based on a two-dimensional (2D) image (e.g., a picture or a video clip) collected by the camera system. The 3D trajectory is illustrative of the past movement of the object-of-interest in a 3D space. Incorporating the 3D trajectory into the 2D image in a real-time fashion enables a user of the camera system to precisely know the past 3D movement trajectory of the object-of-interest while collecting the image associated with the object-of-interest. Benefits of having such 3D trajectories include that it enables the user to predict the movement of the object-of-interest in the near future (e.g., in a tangential direction of the trajectory), such that the user can better manage the image-collection process. It also saves a significant amount of time for a user to further process the collected images by adding the location information of the object-of-interest to the images afterwards.

In some embodiments, the disclosed camera system includes a data collection component, an image component, an analysis component, a trajectory-generation component, an image-incorporation component and a display. The data collection component collects multiple sets of 3D location information of the object-of-interest at different time points. The data collection component can be coupled to suitable sensors used to collect such 3D information. For example, the sensors can be a global positioning system (GPS) sensor, a Global Navigation Satellite System (GLONASS) sensor, or a BeiDou Navigation Satellite System (BDS) sensor. In some embodiments, the suitable sensors can include a barometric sensor (i.e., to determine altitude) and a location sensor that is configured to determine latitudinal and longitudinal information.

After an image associated with the object-of-interest is collected by the image component, the analysis component can then identify a reference object (e.g., a structure in the background of the image) in the collected image. The system then retrieves 3D location information of the reference object. In some embodiments, for example, the system can communicate with a database that stores 3D location information for various reference objects (e.g., terrain information in an area, building/structure information in a city, etc.). In such embodiments, the system can retrieve 3D location information associated with the identified reference object from the database. The database can be a remote database or a database positioned inside the system (e.g., in a sports camera).

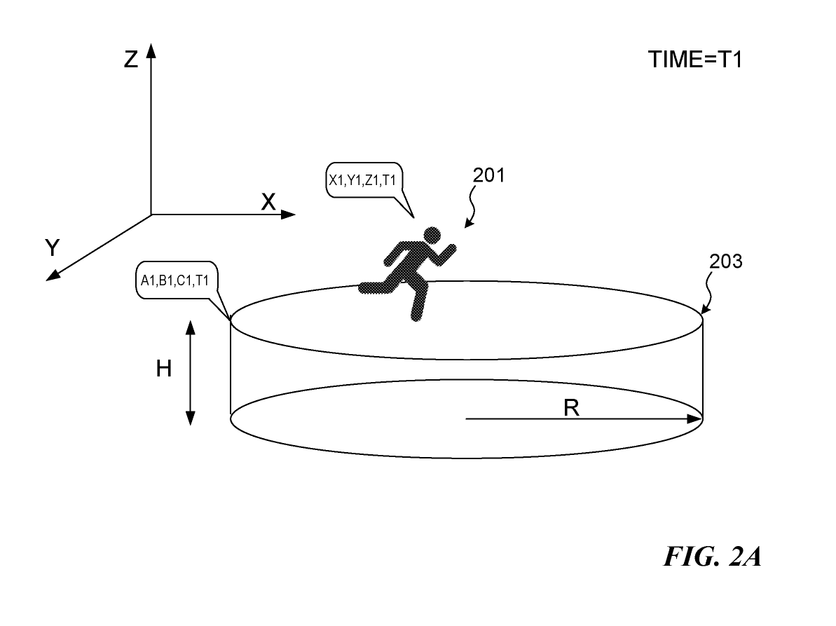

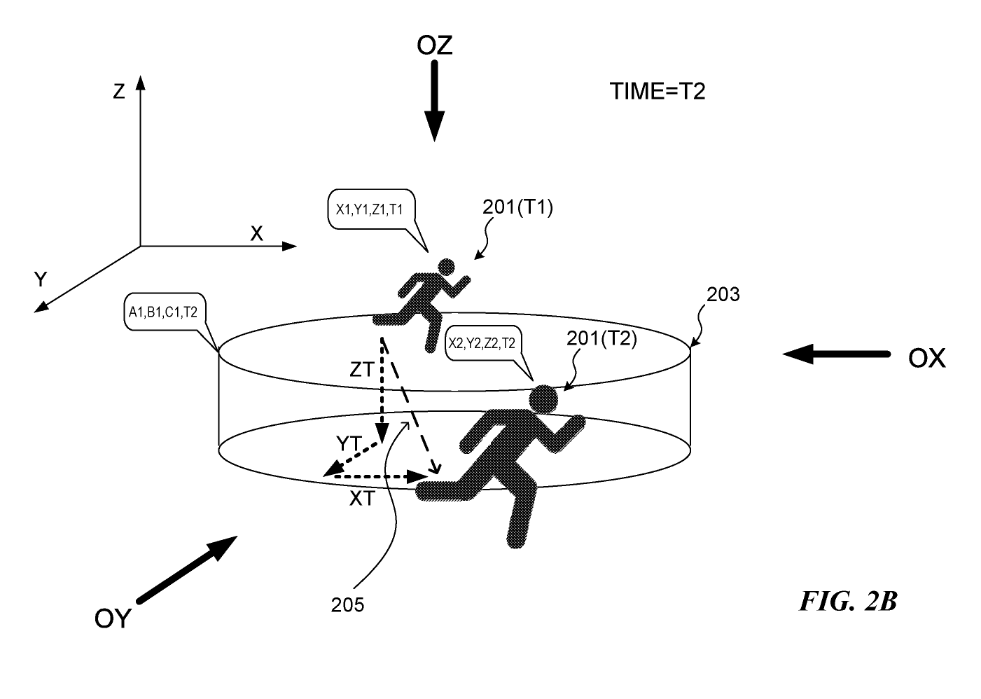

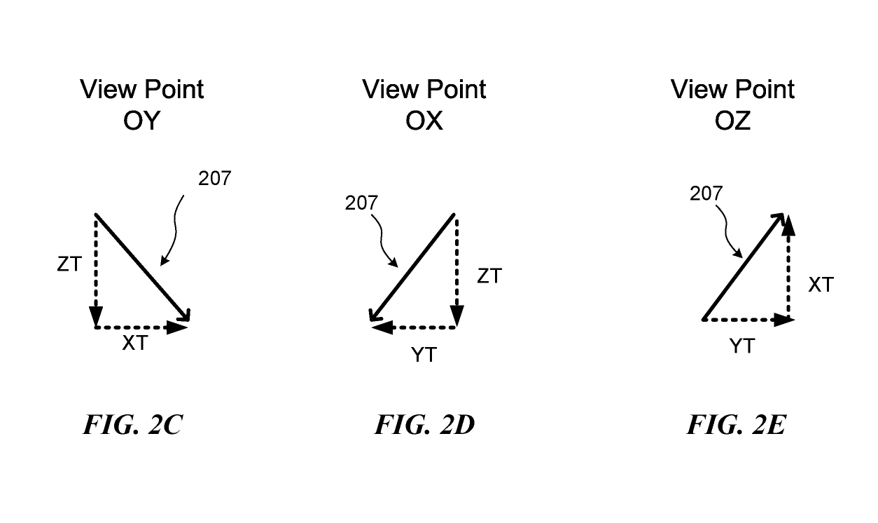

Based on the collected 3D information associated with the object-of-interest and the retrieved 3D information associated with the reference object, the trajectory-generation component can generate a trajectory image. In some embodiments, the trajectory image is a 2D image projection created from a 3D trajectory (examples of the projection will be discussed in detail with reference to FIGS. 2A-2E). The image-incorporation component then forms an incorporated image by incorporating the trajectory image into the image associated with the object-of-interest. The incorporated image is then visually presented to a user in a real time manner. For example, the user can view the incorporated image on a viewfinder or a display of the camera system.

The present disclosure also provides methods for real-time integrating a 3D trajectory into a 2D image. The method includes, for example, collecting a first set of 3D location information of an object-of-interest at a first time point; collecting a second set of 3D location information of the object-of-interest at a second time point; collecting a 2D image associated with the object-of-interest at the second time point; and identifying a reference object in the 2D image associated with the object-of-interest. The method then retrieves a set of 3D reference information associated with the reference object and forms a trajectory image based on the first set of 3D location information, the second set of 3D location information, and the set of 3D reference information. The trajectory image is then integrated into the 2D image to form an incorporated 2D image. The incorporated 2D image is then visually presented to a user in a real-time fashion.

The present disclosure also provides a user interface to a user, enabling the user to customize the way that the trajectory image is visually presented. In some embodiments, the trajectory image can be overlapped with the collected image. In some embodiments, the trajectory image can be positioned adjacent to the collected image. In some embodiments, the trajectory image can be a line shown in the collected image. In some embodiments, the trajectory image can be dynamically adjusted (e.g., in response to a change of a view point where a user observes the object-of-interest when collecting the image thereof).

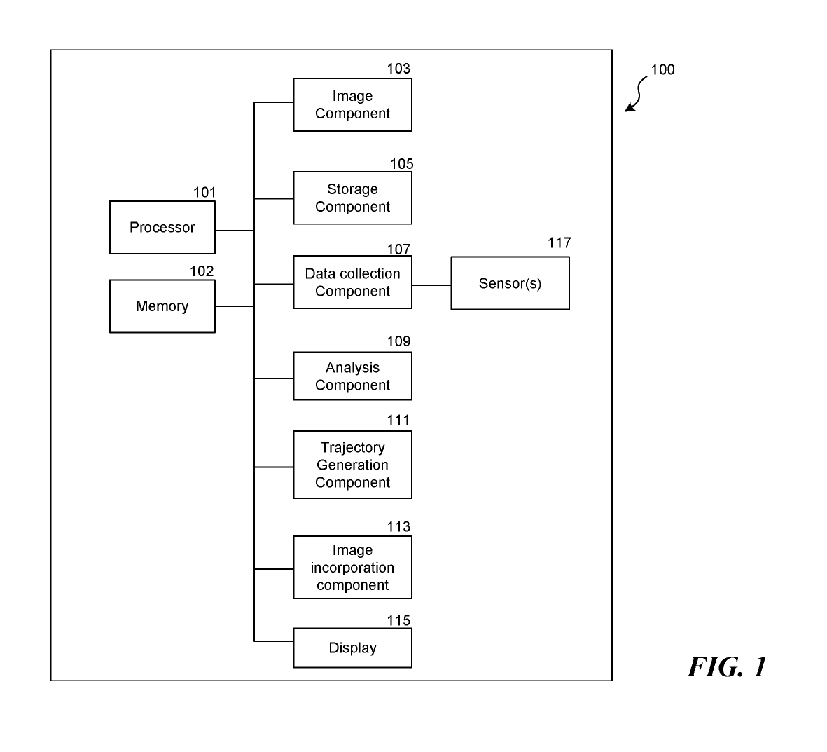

FIG. 1 is a schematic diagram illustrating a system 100 in accordance with embodiments of the disclosed technology. The system 100 includes a processor 101, a memory 102, an image component 103, a storage component 105, a data collection component 107 coupled to one or more sensors 117, an analysis component 109, a trajectory generation component 111, an image incorporation component 113, and a display 115. The processor 101 is configured to control the memory 102 and other components (e.g., components 103-117) in the system 100. The memory 102 is coupled to the processor 101 and configured to store instructions for controlling other components in the system 100.

The image component 103 is configured to capture or collect images (pictures, videos, etc.) from ambient environments of the system 100. For example, the image component 103 can collect images associated with an object-of-interest. Examples of the object-of-interest include moving creatures or moving items such as a person, a wild animal, a vehicle, a vessel, an aircraft, a sports item (e.g., a golf ball), etc. In some embodiments, the object-of-interest can be the system 100 itself. In such embodiments, the image component 103 can collect images surrounding the system 100 while the system is moving. In some embodiments, the image component 103 can be a camera. In some embodiments, the image component 103 can be a video recorder. The storage component 105 is configured to store, temporarily or permanently, information/data/files/signals associated with the system 100. In some embodiments, the storage component 105 can be a hard disk drive. In some embodiments, the storage component 105 can be a memory stick or a memory card.

The analysis component 109 is configured to analyze the collected image associated with the object of interest. In some embodiments, the analysis component 109 identifies a reference object in the collected image with the object of interest. In some embodiments, the reference object can be an article, an item, an area, or a structure in the collected image. For example, the reference object can be a mountain in the background of the image. Once the reference object is identified, the system 100 can retrieve the 3D reference information (or geographic information) of the reference object from an internal database (such as the storage component 105) or an external database. In some embodiments, the trajectory-generation component 111 can perform this information retrieving task. In other embodiments, however, the information retrieving task can be performed by other components in the system 100 (e.g., the analysis component 109). Examples of the 3D reference information of the reference object will be discussed in detail in FIGS. 2A and 2B and corresponding descriptions below.

Through the sensor 117, the data collection component 107 collects 3D location information of the system 100. In some embodiments, the sensor 117 can be a GPS sensor, a GLONASS sensor, or a BDS sensor. In such embodiments, the sensor 117 can measure the 3D location of the system 100 via satellite signals. For example, the sensor 117 can generate the 3D location information in a coordinate form, such as (X, Y, Z). In the illustrated embodiment, “X” represents longitudinal information of the system 100, “Y” represents latitudinal information of the system 100, and “Z” represents altitudinal information of the system 100. In some embodiments, the sensors 117 can include a barometric sensor configured to measure altitude information of the system 100 and a location sensor configured to measure latitudinal and longitudinal information of the system 100.

After receiving the 3D location information of the system 100, the data collection component 107 can generate 3D location information of an object-of-interest. For example, the object-of-interest can be a skier holding the system 100 and collecting selfie images when moving. In such embodiments, the 3D location information of the system 100 can be considered as the 3D location information of the object-of-interest. In some embodiments, the object-of-interest can be a wild animal and the system 100 can be a drone camera system moving with the wild animal. In such embodiments, the drone camera system can maintain a distance (e.g., 100 meter) with the wild animal. The data collection component 107 can generate the 3D location information of the object-of-interest based on the 3D location information of the system 100 with a proper adjustment in accordance with the distance between the system 100 and the object-of-interest. The data collection component 107 can generate the 3D location information of an object-of-interest at multiple time points and store it in the storage component 105.

Once the system 100 receives the 3D reference information of the reference object and the 3D location information of the object-of-interest at multiple time points, the trajectory generation component 111 can form a 2D trajectory image based on the received 3D information. The trajectory generation component 111 can determine the 3D location of the object-of-interest relative to the reference object. For example, the trajectory generation component 111 can determine that, at certain point, the object-of-interest was locating 1 meter above the reference object. Based on the received 3D information at different time points, the trajectory generation component 111 can generate a 3D trajectory indicating the movement of the object-of-interest. Further, the trajectory generation component 111 can accordingly create the 2D trajectory image when a view point of the system 100 is determined. In some embodiments, the 2D trajectory image is a 2D image projection created from the 3D trajectory. Examples of the 2D trajectory image will be discussed in detail in FIGS. 2A-2E and the corresponding descriptions below.

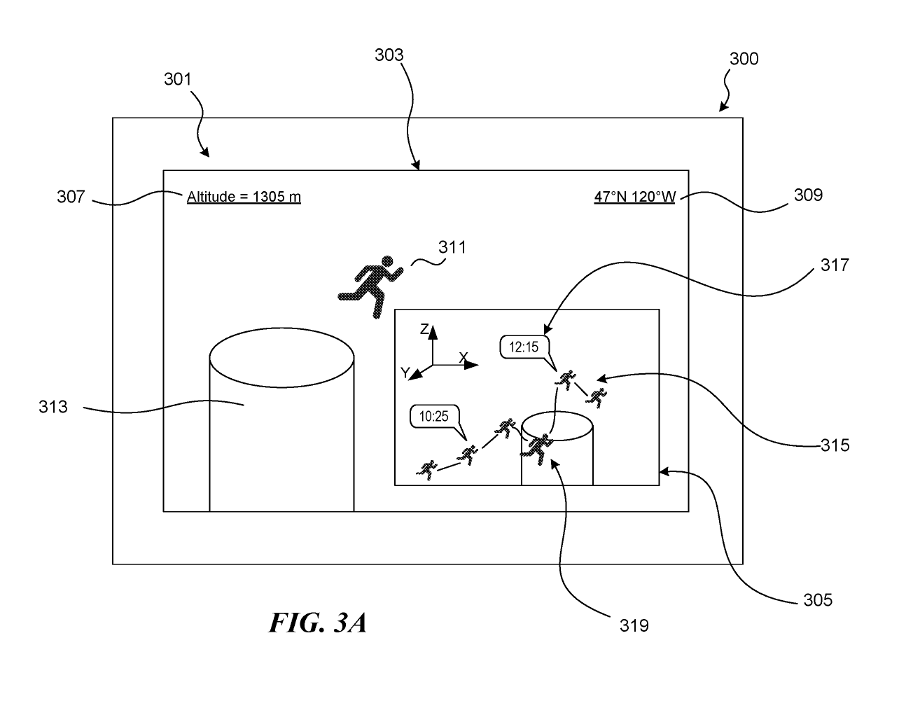

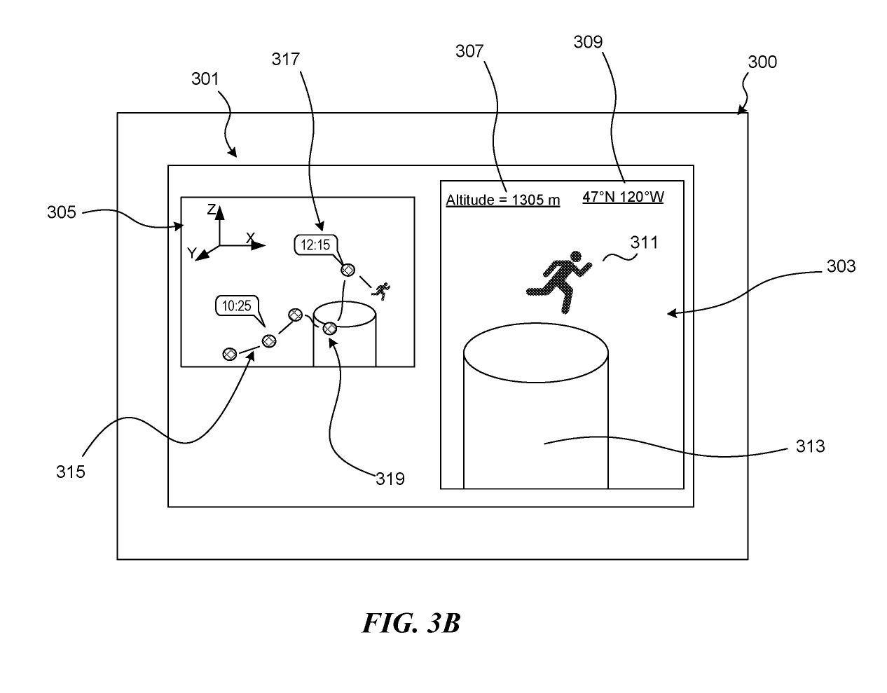

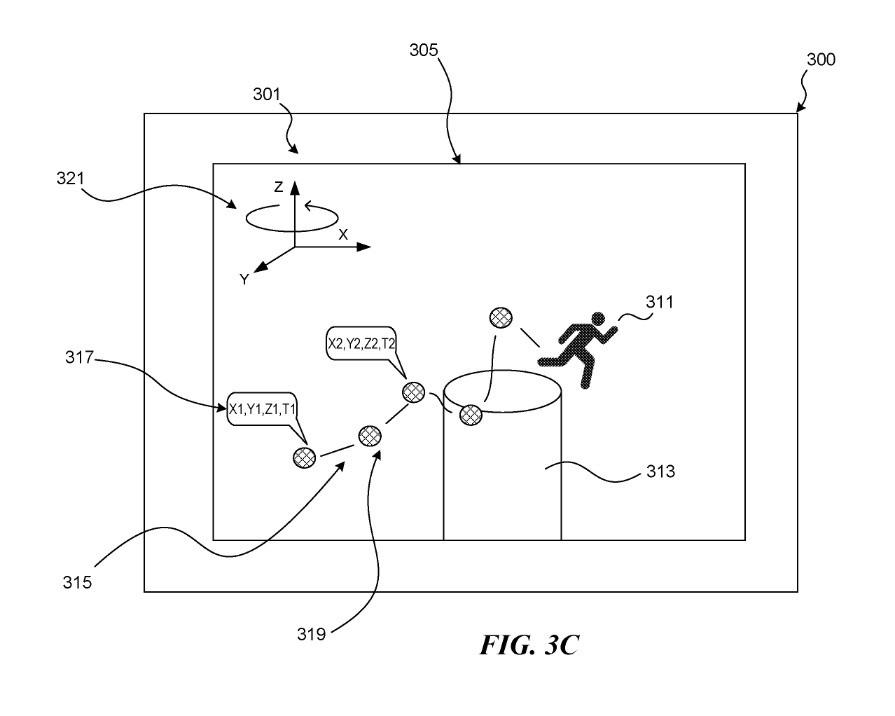

After the trajectory image is created, the image incorporation component 113 can incorporate the trajectory image into the collected image associated with the object-of-interest so as to form an incorporated image. The display 115 can then visually present the incorporated image to a user through a user interface. Embodiments of the user interface will be discussed in detail in FIGS. 3A-3C and the corresponding descriptions below. In some embodiments, the integrated images can be transmitted to a remote device (e.g., a server or a mobile device) via a network (e.g., a wireless network) in a real-time manner.

FIG. 2A is a schematic diagram illustrating an object-of-interest 201 and a reference object 203 in accordance with embodiments of the disclosed technology. FIG. 2A illustrates the relative locations of the object-of-interest 201 and the reference object 203 at a first time point T1. In the illustrated embodiments shown in FIG. 2A, the object-of-interest 201 is a running person located at (X1, Y1, Z1). The reference object 203 is a cylindrical structure located at (A1, B1, C1) with height H and radius R. In other embodiments, the locations of the object-of-interest and the reference object 203 can be shown in different formats. At the first time point T1, the data collection component 107 can measure (e.g., by the sensor 117 as discussed above) the 3D location information of the object-of-interest 201 and store the measured information. The trajectory generation component 111 can retrieve the location information of the reference object 203 at the first time point T1.

FIG. 2B is a schematic diagram illustrating a 3D trajectory 205 of the object-of-interest 201 in accordance with embodiments of the disclosed technology. FIG. 2B illustrates the relative locations of the object-of-interest 201 and the reference object 203 at a second time point T2. As shown in FIG. 2B, the object-of-interest 201 moves from (X1, Y1, Z1) to (X2, Y2, Z2). The 3D trajectory 205 between these two locations can be calculated and recorded by the trajectory-generation component 111. As shown, the 3D trajectory 205 can be divided as three vectors, namely vector XT in the X-axis direction, vector YT in the Y-axis direction, and vector ZT in the Z-axis direction. In the illustrated embodiments, the reference object 203 does not move during the time period from the first time point T1 to the second time point T2. Based on the 3D trajectory 305 and a view point of the system 100, the trajectory-generation component 111 can determine a suitable trajectory image. For example, if a user of the system 100 is observing the object-of-interest 201 from point OY in the Y-axis direction, the trajectory image 207 is calculated by adding the vector ZT and the vector XT, as shown in FIG. 2C. Similarly, if the user of the system 100 is observing the object-of-interest 201 from point OX in the X-axis direction, the trajectory image 207 is calculated by adding the vector ZT and the vector YT, as shown in FIG. 2D. If the user of the system 100 is observing the object-of-interest 201 from point OZ in the Z-axis direction, the trajectory image 207 is calculated by adding the vector YT and the vector XT, as shown in FIG. 2E. The trajectory-generation component 111 will calculate the locations of the object-of-interest 201 at multiple time points and accordingly generate the trajectory image 207. After the trajectory image is created, the image incorporation component 113 can incorporate the trajectory image 207 into the collected image associated with the object-of-interest 201 so as to form an incorporated image to be displayed via a user interface, as discussed in FIGS. 3A-3B below.

FIG. 3A-3C are schematic diagrams illustrating user interfaces in accordance with embodiments of the disclosed technology. In FIG. 3A, a display 300 includes user interface 301. The user interface 301 includes a first section 303 configured to visually present the collected image, and a second section 305 configured to visually present the incorporated image created by the image incorporation component 113. In FIG. 3A, the first section 303 and the second section 305 are overlapped. As shown in FIG. 3A, the first section 303 can display location information 309 the system 100, altitude information 307 of the system 100, an object of interest 311 and a reference object 313. In other embodiments, the location information 309 and the altitude information 307 can be of the object-of-interest 311. As shown in the second section 305, the incorporated image can include a trajectory image 315 which includes multiple symbols 319. Each of the symbols 319 represents the object-of-interest 311 at different time points. In the illustrated embodiments, the size of the symbol 319 can represent the distance between the object-of-interest 311 and the view point of the system 100. For example, a larger sized symbol 319 means the object-of-interest 311 has a shorter distance to the system 100. The incorporated image can also include multiple time tags 317 corresponding to the symbols 319, so as to show the individual time points associated with the individual symbols 319.

In the embodiments shown in FIG. 3B, the first section 303 and the second section 305 are not overlapped. In addition, the multiple symbols 319 in the trajectory 315 image can have the same size, except the symbol 319 that represents the most recent location or the current location of the object-of-interest 311. In the embodiments shown in FIG. 3C, the user inter face 301 can only have the second section 305 showing the incorporated image. In the illustrated embodiments in FIG. 3C, the user interface 301 includes a rotatable axis symbol 321 that enables a user of the system 100 to dynamically change the view point of the system 100 by rotating the rotatable axis symbol 321 through the user interface 301.

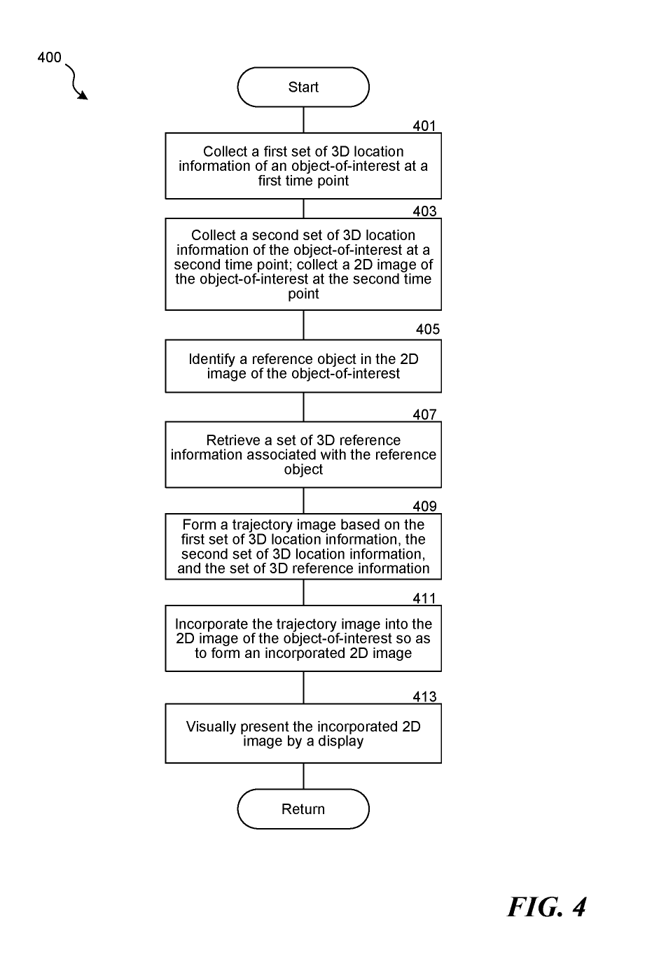

FIG. 4 is a flow chart illustrating operations of a method 400 in accordance with embodiments of the disclosed technology. The method 400 can be implemented by an associated system (such as the system 100 discussed above). At block 401, the system collects a first set of 3D location information of an object-of-interest at a first time point. At block 403, the system collects a second set of 3D location information of the object-of-interest and collects a 2D image associated with the object-of-interest at a second time point. After the image associated with the object-of-interest is collected, the system then identifies a reference object in the 2D image at block 405. The method 400 then moves to block 407 to retrieve a set of 3D reference information associated with the reference object. At block 409, the system then forms a trajectory image based on the first set of 3D location information, the second set of 3D location information, and the set of 3D reference information. At block 411, the system then incorporates the trajectory image into the 2D image associated with the object-of-interest so as to form an incorporated 2D image. The method 400 continues to block 413 and the system visually displays the incorporated 2D image by a display. The method 400 then returns.

Although the present technology has been described with reference to specific exemplary embodiments, it will be recognized that the present technology is not limited to the embodiments described but can be practiced with modification and alteration within the spirit and scope of the appended claims. Accordingly, the specification and drawings are to be regarded in an illustrative sense rather than a restrictive sense.

1. A method for integrating a three-dimensional (3D) trajectory into a two-dimensional (2D) image, the method comprising:
collecting a first set of 3D location information of an object-of-interest at a first time point;
collecting a second set of 3D location information of the object-of-interest at a second time point;
collecting a 2D image associated with the object-of-interest at the second time point;
identifying a reference object in the 2D image associated with the object-of-interest;
retrieving a set of 3D reference information associated with the reference object;
forming a trajectory image based on the first set of 3D location information, the second set of 3D location information, and the set of 3D reference information;
incorporating the trajectory image into the 2D image associated with the object-of-interest so as to form an incorporated 2D image; and
visually presenting the incorporated 2D image by a display.

2. The method of claim 1, further comprising:
receiving a set of 3D background geographic information from a server; and
storing the set of 3D background geographic information in a storage device;
wherein the set of 3D reference information associated with the reference object is retrieved from the set of 3D background geographic information stored in the storage device.

3. The method of claim 1, wherein collecting the first set of 3D location information of the object-of-interest includes collecting a set of altitude information by a barometric sensor.

4. The method of claim 3, wherein collecting the first 3D location information of the object-of-interest includes collecting a set of longitudinal and latitudinal information by a location sensor.

5. The method of claim 1, wherein the first 3D location information of the object-of-interest is collected by a global positioning system (GPS) sensor.

6. The method of claim 1, wherein the first 3D location information of the object-of-interest is collected by a BeiDou Navigation Satellite System (BDS) sensor.

7. The method of claim 1, wherein the first 3D location information of the object-of-interest is collected by a Global Navigation Satellite System (GLONASS) sensor.

8. The method of claim 1, wherein a user interface is presented in the display, and wherein the user interface includes a first section showing the 2D image associated with the object-of-interest and a second section showing the incorporated 2D image.

9. The method of claim 8, wherein the first section and the second section are overlapped.

10. The method of claim 1, wherein the trajectory image includes a first tag corresponding to the first time point and a second tag corresponding to the second time point.

11. The method of claim 1, wherein the 2D image associated with the object-of-interest is collected by a sports camera, and wherein the first and second sets of 3D location information are collected by a sensor positioned in the sports camera.

12. The method of claim 1, wherein the reference object is an area selected from a ground surface, and wherein the set of 3D reference information associated with the reference object includes a set of 3D terrain information.

13. The method of claim 1, further comprising dynamically changing a view point of the trajectory image.

14. The method of claim 13, wherein dynamically changing the view point of the trajectory image comprises:
receiving an instruction from a user to rotate the 3D trajectory image about an axis;
in response to the instruction, adjusting the view point of the trajectory image; and
updating the trajectory image.

15. A system for integrating a trajectory into an image, the system comprising:
a data collection component configured to collect a first set of 3D location information of an object-of-interest at a first time point and a second set of 3D location information of the object-of-interest at a second time point;
a storage component configured to store the first set of 3D location information and the second set of 3D location information;
an image component configured to collect an image associated with the object-of-interest at the second time point;
an analysis component configured to identify a reference object in the image associated with the object of interest;
a trajectory-generation component configured to retrieve a set of 3D reference information associated with the reference object and form a trajectory image based on the first set of 3D location information, the second set of 3D location information, and the set of 3D reference information;
an image-incorporation component configured to form an incorporated image by incorporating the trajectory image into the image associated with the object-of-interest; and
a display configured to visually present the incorporated image.

16. The system of claim 15, wherein the trajectory-generation component dynamically changes a view point of the trajectory image.

17. The system of claim 15, wherein the data collection component is coupled to a sensor for collecting the first and second sets of 3D location information of the object-of-interest.

18. A method for visually presenting a trajectory of an object-of-interest, the method comprising:
collecting a first set of 3D location information of the object-of-interest at a first time point;
collecting a second set of 3D location information of the object-of-interest at a second time point;
collecting an image associated with the object-of-interest at the second time point;
identifying a reference object in the image associated with the object-of-interest;
retrieving a set of 3D reference information associated with the reference object;
forming a trajectory image based on the first set of 3D location information, the second set of 3D location information, and the set of 3D reference information;
forming an integrated image by incorporating the trajectory image into the image associated with the object-of-interest;
visually presenting the image associated with the object-of-interest in a first section on a display; and
visually presenting the incorporated image in a second section on a display.

19. The method of claim 18, wherein the first section and the second section are overlapped, and wherein the first section is larger than the second section.

20. The method of claim 19, further comprising dynamically adjusting a size of the second section on the display.
